(19) United States
(12) Patent Application Publication
(10) Pub. No.: US 2009/0128046 A1
(43) Pub. Date: May 21, 2009

(54) Rectifier module for LED lamp strings

(76) Inventor: Chang Fu Tsai, Taichung (TW)

Correspondence Address: Joe McKinney Muncy, PO Box 1364, Fairfax, VA, 22038-1364, US

(21) Appl. No.: 11/984,411

(22) Filed: Nov. 16, 2007

(51) Int. Cl. F21S 4/00

(52) U.S. Cl. 315/185 S

(57) ABSTRACT

A rectifier module is provided for simultaneous use with a plurality of light-emitting diode (LED) lamp strings. The rectifier module includes an extension cable having first and second ends to which first and second connectors are mounted and a casing mounted to the extension cable and including therein an electronic circuit. The electronic circuit includes a rectifier element, which can be a diode based circuit or a bridge rectifier, to which a resistor and a capacitor are electrically connected. The resistor can be a variable resistor to allow for manual adjustment. The casing can be mounted to a middle portion of the extension cable or, if desired, can be integrated with either one of the connectors.

### BACKGROUND OF THE INVENTION

1. Field of the Invention

The present invention relates to a rectifier module, and in particular to a rectifier module for simultaneous use with multiple light-emitting diode (LED) lamp strings.

2. The Related Arts

A light-emitting diode (LED) lamp string is necessarily provided with a rectifier to realize current regulation and to eliminate flashing of the light emitted from the LEDs, which may cause uncomfortableness of eyes of users. Conventionally, each LED lamp string must be equipped with its own rectification filter circuit, such a conventional rectification circuit does not allow for adjustment of dimming of the LED lamps. The conventional rectification circuit is usually composed of a bridge circuit or alternatively a single diode or plural diodes to realize rectification of current. Some of the know LED lamp string rectification circuits include a capacitor for filter and thus stabilize the current supplied to the LED lamps. No matter how the conventional rectification circuits are constructed, they are all designed to each work with a single lamp string. On the other hand, the lamp strings are generally for decoration purposes and are often used in multiplicity. This means, there must be the same number of rectifiers included in the decoration arrangement that is formed with the multiple LED lamp strings. This apparently increases the overall costs of the decoration arrangement and makes the decoration arrangement complicated. Further, such a large number of rectifiers, if not properly arranged, may deteriorate the aesthetic configuration to be realized by the decoration arrangement based on the LED lamp strings.

FIG. 1 of the attached drawings illustrates a schematic view of a conventional LED lamp string, designated at 10, that includes an individual rectifier 11. The rectifier 11 is directly connected to a cable of the LED lamp string 10. The cable that is also provided with a plug or other type of electrical connector, for connection with an external power supply. Since each of the conventional LED lamp string 10 requires a rectifier 11, it is to the convenience of use and manufacturing that the rectifier 11 is directly connected to the LED lamp string 10.

The LED lamp string that includes the conventional arrangement of rectification circuit has the following disadvantages:

(1) Since each LED lamp string needs its own rectifier, the overall cost of a decoration arrangement that includes a great number of LED lamp strings is inevitably increased by a substantial amount associated with the rectifiers. Such an increased cost is eventually born by the general consumers.

(2) In case of a decoration scene that is constituted by a great number of LED lamp strings, the same number of rectifiers must be included in the scene and such great number of rectifiers inevitably brings about negative influence to the overall aesthetics of the decoration and deteriorates the decorative effect provided by the LED lamp strings.

(3) The conventional rectifier is integrated with the associated LED lamp string and this imposes limitation to further use of the rectifier.

Thus, it is desired to provide a rectifier module for simultaneous use with multiple LED lamp strings and featuring adjustment of dimming or brightness of the LED lamps so as to overcome the drawbacks of the conventional LED lamp strings.

### SUMMARY OF THE INVENTION

In view of the above discussion, it is found that the problems to be addressed are that the conventional rectifier can only work with an individual LED lamp string so that each lamp string must be equipped with its own rectifier. This increases the total number of rectifiers in a decoration arrangement including multiple LED lamp strings and in turn increases the overall costs, which must be eventually born by the general consumers who purchase the LED lamp strings. Further, one of the purposes of using LED lamp strings is to provide a decoration arrangement, the great number of rectifiers that must be included in a decoration arrangement including the same number of LED lamp strings inevitably causes negative influence on the overall visual aesthetics of the decoration arrangement, deteriorating the decorative effect. In addition, the conventional rectifier is integrated with the associated LED lamp string and this prevents the rectifier from other uses or applications.

In accordance with the present invention, a solution to the above listed problems includes a rectifier module, which combines rectification circuits that are needed for a great number of LED lamp strings together as a single unit or module mounted to an extension cable to which various LED lamp strings may externally and releasably connected. In accordance with the present invention, the rectifier module comprises an extension cable having first and second ends to which first and second connectors are mounted and a casing mounted to the extension cable and including therein an electronic circuit. The first connector can be for example a plug for connection with an external power source, such as a wall outlet, while the second connector may be made in the form of a multiple-receptacle electrical socket or connection of any desired configuration for selective and releasably connecting a plug or a mated connection of each of the multiple LED lamp strings. The electronic circuit comprises a rectifier element, which can be a diode based rectification circuit or a bridge rectifier, to which a resistor and a capacitor are electrically connected. The resistor can be a variable resistor to allow for manual adjustment. The electronic circuit can be made as a unitary device enclosed inside the casing or, if desired, be integrated with either one of the connectors. The rectifier element can be a circuit including a bridge rectification circuit, or a circuit including a single diode or a plurality of diodes. And, a capacitor can be added in the circuit to serve as a filter for stabilizing the output of the circuit. A variable resistor can be included for realizing manual adjustment of dimming or brightness of the LED lamp strings.

As compared to the conventional LED lamp strings, the present invention has at least the following advantages:

(1) On the contrary to the conventional LED lamp string configuration where each LED lamp string needs its own rectifier, the present invention requires only a single rectifier module to work with around twenty LED lamp strings. This substantially reduces the number of the rectification circuit and thus reduces the overall cost of a decoration arrangement including a great number of LED lamp strings.

(2) Since the conventional LED lamp string configuration requires a rectifier for each LED lamp string, the conventional lamp string is often made in the form of a long linear series of LED lamps connected to a cable, which prevents the rectifier from other applications or uses. The present invention, however, allows for a single rectifier module to work with two to twenty LED lamp strings and is made in a modularized form to allow for other applications and uses of the rectifier module.

(3) In the conventional LED lamp string arrangement that includes a great number of LED lamp strings, the same number of rectifiers must be included also and such a great number of rectifiers deteriorate the decorative aesthetics. However, the present invention allows a single rectifier module to work with two to twenty LED lamp strings and thus requiring no such a great number of rectifiers whereby the decorative aesthetics can be enhanced.

### BRIEF DESCRIPTION OF THE DRAWINGS

The present invention will be apparent to those skilled in the art by reading the following description of preferred embodiments thereof, with reference to the attached drawings, wherein:

FIG. 1 is a schematic view showing a conventional light-emitting diode (LED) lamp string;

FIG. 2 is a schematic view showing a rectifier module constructed in accordance with the present invention in connection with a plurality of LED lamp strings;

FIG. 3 is a circuit diagram showing an electronic circuit included in the rectifier module of the present invention;

FIG. 4 is a perspective view illustrating an LED lamp string arrangement including a plurality of LED lamp strings and a single rectifier module in accordance with another embodiment of the present invention;

FIG. 5 is a schematic view illustrating an application of the LED lamp strings controlled by a rectifier module that are positioned on a Christmas tree;

FIGS. 6A-6H illustrate different embodiments of the electronic circuits of the rectifier module in accordance with the present invention;

FIG. 7 is a perspective view illustrating a fool-proof mechanism included in the rectifier module in accordance with the present invention;

FIG. 8 is a perspective view illustrating a rectifier module constructed in accordance with an embodiment of the present invention; and

FIG. 9 is a perspective view illustrating a rectifier module constructed in accordance with another embodiment of the present invention.

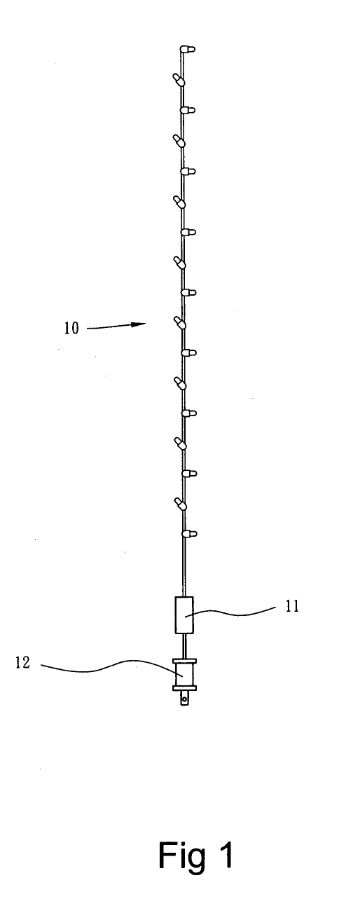

### DETAILED DESCRIPTION OF THE PREFERRED EMBODIMENTS

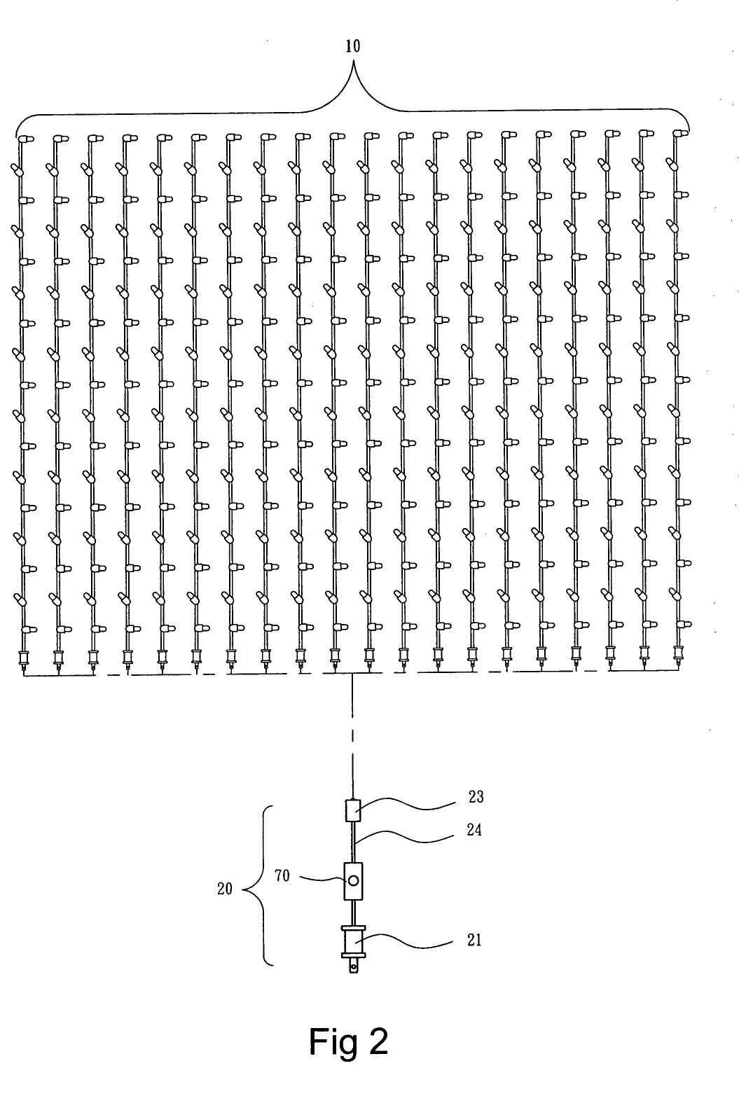

With reference to the drawings and in particular to FIG. 2, a rectifier module constructed in accordance the present invention, generally designated at 20 is provided for simultaneous use with a plurality of light-emitting diode (LED) lamp strings 10. The rectifier module 20 comprises a plug 21, which can be alternatively any suitable type of electrical connection, and an electronic circuit 70, which includes a rectifier element and is mounted to an extension cable 24. The cable 24 has a first end to which the plug 21 is mounted and an opposite second end to which a socket 23, or other suitable electrical connection, is mounted. Thus, the extension cable 24 having opposite ends forming the plug 21 and the socket 23 and the electronic circuit comprised of the rectifier element together constitute the rectifier module 20 in accordance with the present invention.

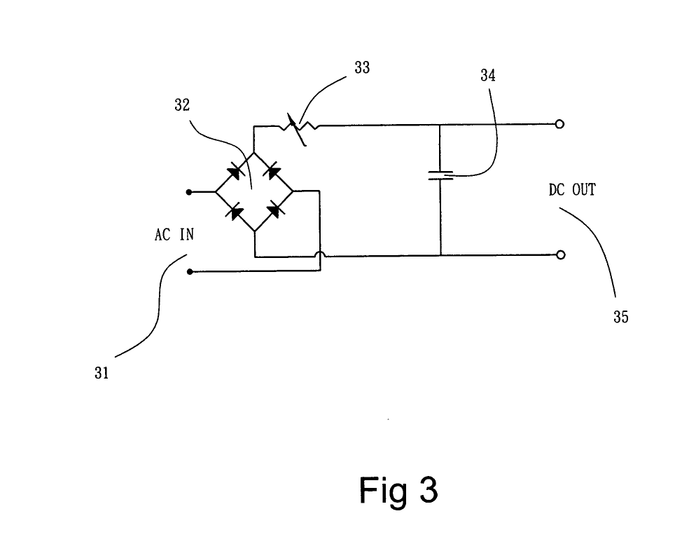

Also referring to FIG. 3, the rectifier module 20 for LED lamp strings in accordance with the present invention comprises the electronic circuit 70 that comprises a rectifier element 32, a resistor element 33, and a capacitor element 34. The rectifier element 32 can comprise a bridge rectification filter. The resistor element 33 may comprise a variable resistor.

In an embodiment of the present invention, the rectifier module 20 of the present invention can be electrically and simultaneously connected to around twenty (20) LED lamp strings 10, as shown in FIG. 2 so that the need for installing an individual rectifier for each LED lamp string 10 can be removed. This allows saving of the costs of materials and labor hours required to manufacture a great number of rectifiers. The arrangement of the variable resistor in the electronic circuit 70 allows for manual adjustment of the brightness of the lamp strings 10 as desired. Further, there is no need to purchase individual LED lamp string that is incorporated its own rectifier, for such a lamp string is of higher expense. In this respect, the present invention provides the general consumers with a less expensive option. Adding a bridge rectifier circuit with a variable resistor allows the lamp string to be controlled in a simple and straightforward manner. It is practical in the use of the LED lamp strings.

Alternatively, the bridge rectifier circuit can be replaced by a diode based rectification circuit.

Referring now to FIG. 3, which shows an example of the electronic circuit 70 of the rectifier module of the present invention, the electronic circuit 70 comprises an alternate current (AC) input 31, which is also labeled “AC IN” in FIG. 3. The AC input 31 is electrically connected to a bridge rectifier element 32, and then further electrically connected to the variable resistor of the resistor element 33 and the capacitor element 34 to provide a direct current (DC) output 35.

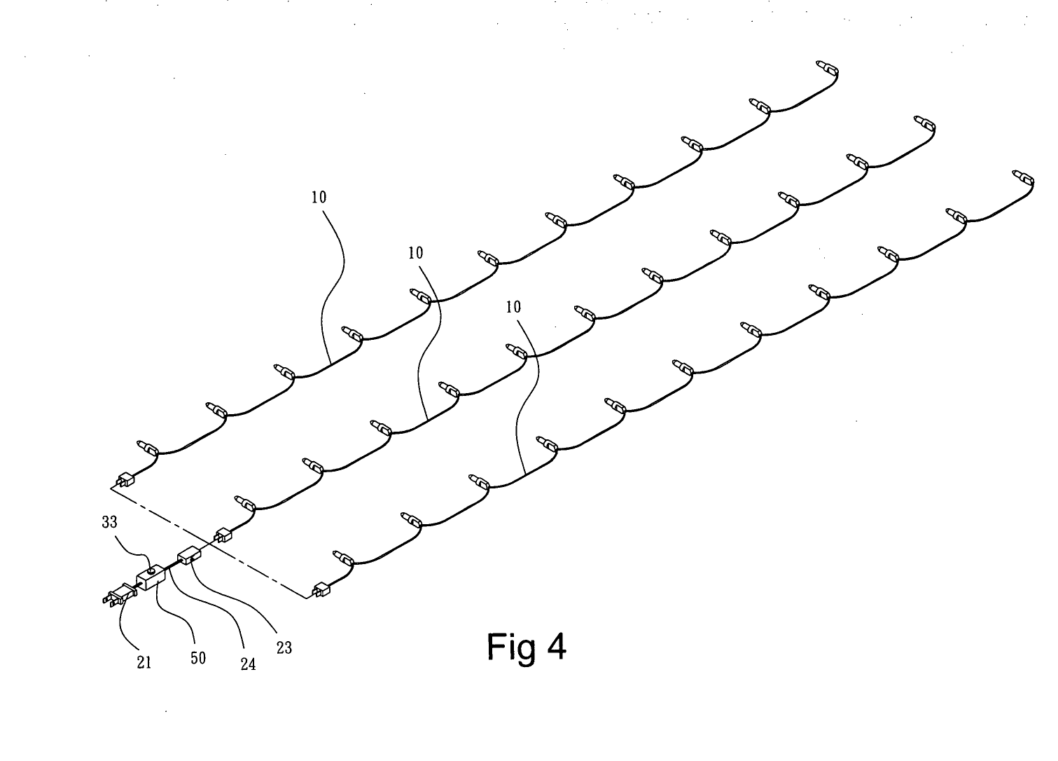

Also referring to FIG. 4, the electronic circuit 70 of the rectifier module 20 can be simultaneously connected to a plurality of LED lamp strings 10. In other words, the present invention combines individual rectifiers for each of the lamp strings 10 together to form a single rectifier module 20, which is mounted to an extension cable 24 with the rectifier module 20 having an AC input and a DC output. Alternatively, the electronic circuit can be embodied as a printed circuit board to provide a modularized electronic circuit.

The electronic circuit can be selectively arranged in the first end connector 21, the second end connector 23 or inside a plastic casing 50 that is mounted to the extension cable. As compared to the conventional LED lamp string, which requires an individual rectifier for each lamp string, the present invention provides a cheap and light-weighted and compact solution. In addition, the electronic circuit of the rectifier module of the present invention can be added with a variable resistor based resistor element 33, which allows for manual and ready adjustment of the brightness of the LED lamp strings.

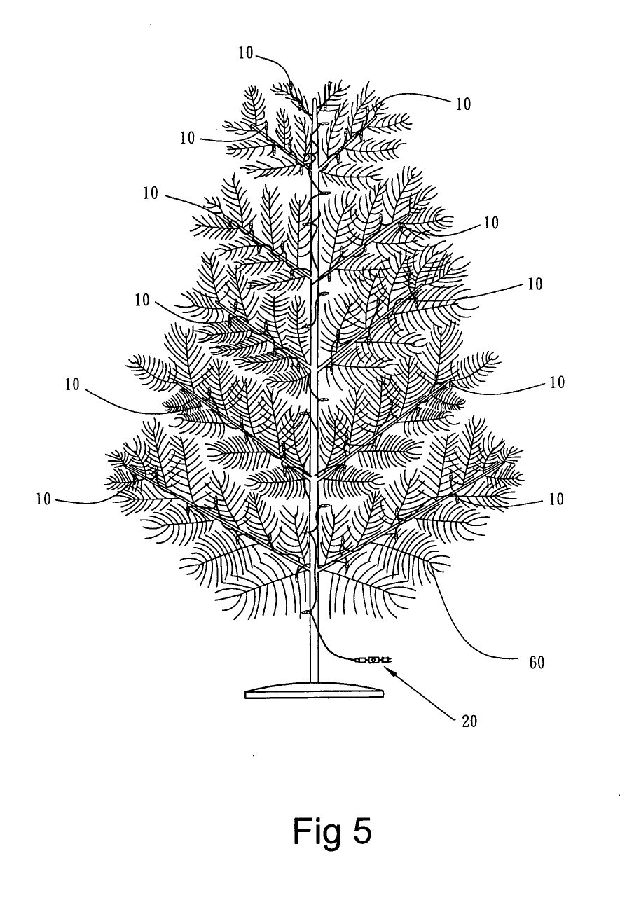

Referring to FIG. 5, a Christmas tree 60 may be decorated with the LED lamp strings 10 and in such an application, the most important function of the lamp strings 10 is decoration. For the conventional lamp strings that each requires an individual rectifier, the great number of rectifiers hanging on the tree branches, which is not necessary for tungsten filament lamp string, certainly obstacle the aesthetic appearance of the Christmas tree 60 and the consumers have to bear the extra costs for the rectifiers. On the contrary, in accordance with the present invention, only a single rectifier module is required for all the lamp strings 10 positioned on and attached to the Christmas tree 60 and this provides enhanced aesthetic effect.

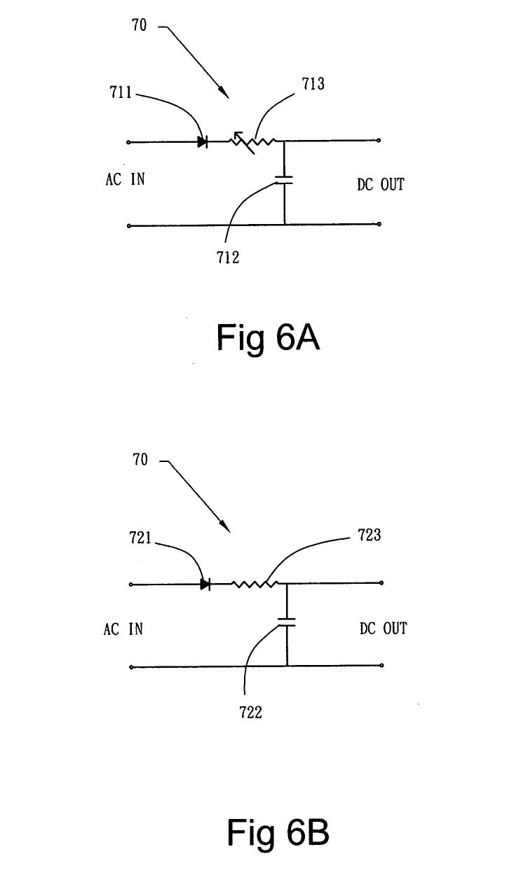

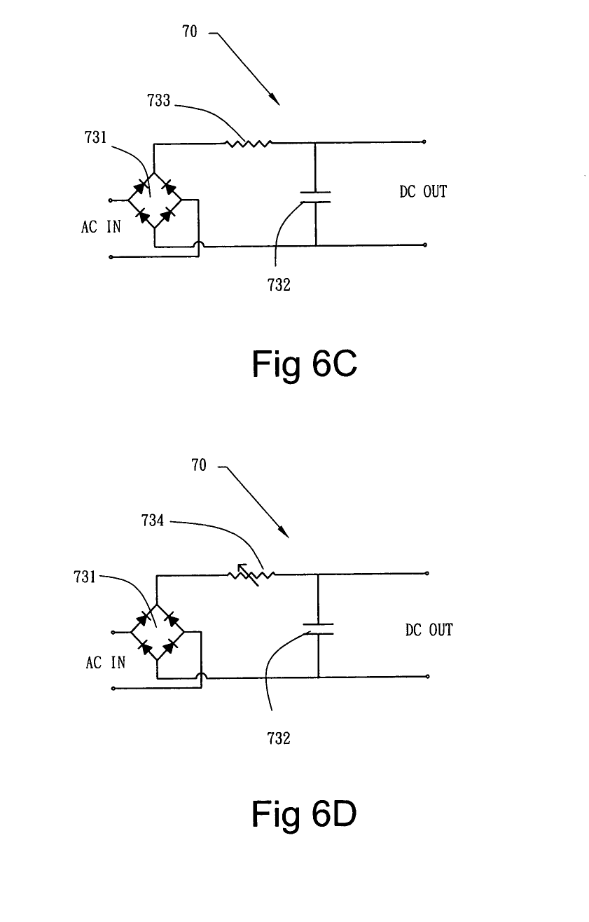

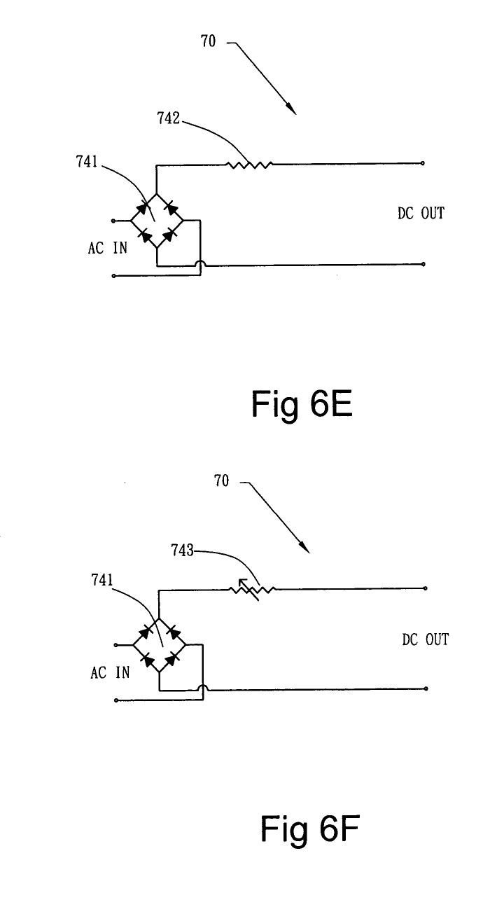

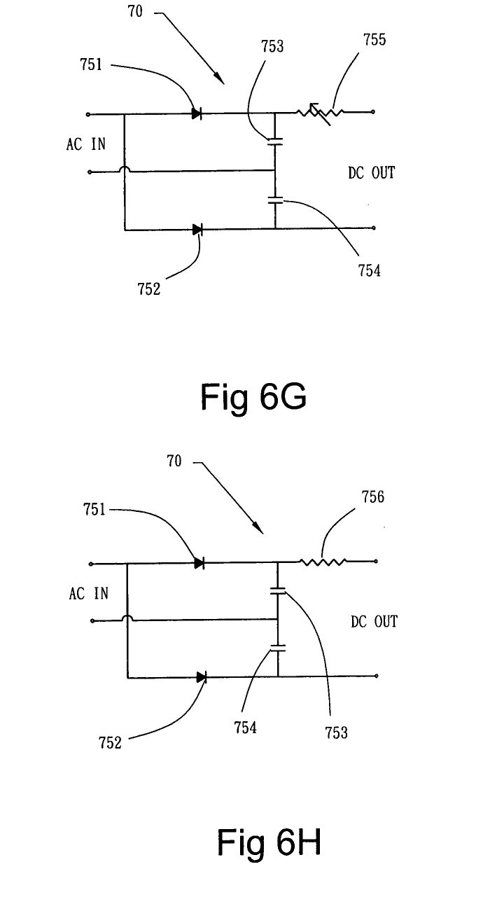

Referring to FIG. 6A, which shows another embodiment of the electronic circuit 70 for the rectifier module of the present invention, the electronic circuit 70 comprises a single diode 711 connected to a capacitor 712 and a variable resistor 713.

Referring to FIG. 6B, which shows a further embodiment of the electronic circuit 70 for the rectifier module of the present invention, the electronic circuit 70 comprises a single diode 721 connected to a capacitor 722 and a constant resistor 723.

Referring to FIGS. 6C and 6D, which show further embodiments of the electronic circuit 70 for the rectifier module of the present invention, the electronic circuits 70 illustrated in FIGS. 6C and 6D comprise a bridge rectification filter 731 connected to a capacitor 732 and a constant resistor 733 or a variable resistor 734, respectively.

Referring to FIGS. 6E and 6F, further embodiments of the electronic circuit 70 for the rectifier module of the present invention are respectively shown. The electronic circuit 70 of FIG. 6E comprises a bridge rectification filter 741 connected to a constant resistor 742 and the electronic circuit 70 of FIG. 6F comprises a bridge circuit 741 connected to a variable resistor 743.

Referring to FIGS. 6G and 6H, further embodiments of the electronic circuit 70 for the rectifier module of the present invention are respectively shown. The electronic circuit 70 of FIG. 6G comprises two diodes 751, 752 to which a circuit comprised of two capacitors 753, 754 and a variable resistor 755 is connected. The electronic circuit 70 of FIG. 6H comprises two diodes 751, 752 to which a circuit comprised of two capacitors 753, 754 and a constant resistor 756 is connected.

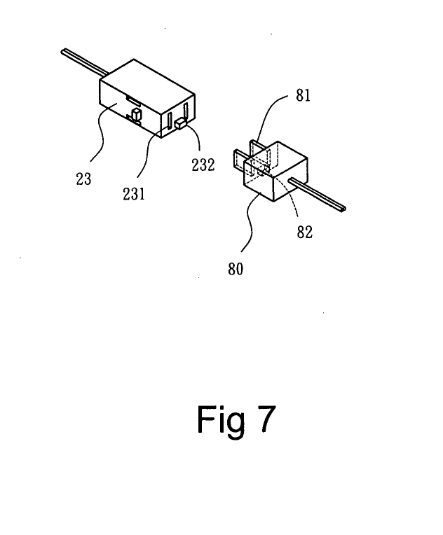

Referring to FIG. 7, the second end connector 23 is formed as an electrical socket and has the form of a rectangular box. The front face and lateral side faces of the rectangular box can be formed with plugging slots 231 for receiving plugging blades 81 of a plug 80 of an associated LED lamp string 10 to plug therein. An eccentric notch 82 is formed between two blades 81 of the plug 80 and corresponding thereto, the second end connector 23 forms an eccentrically arranged boss 232 at a location corresponding to notch 82 of the LED lamp string plug 80. The boss 232 is matingly receivable in the notch 82 and the eccentric arrangement provides a fool-proof mechanism so as to prevent incorrect plugging where the boss 232 is not allowed to fit into notch 82 and thus constitutes an obstacle for plugging operation. When the plugging is carried out at correct position, the boss 232 can be fit into the notch 82 to allow the blades 81 of the LED lamp string plug 80 to plug into the slots 231 of the second end connector 23 of the extension cable.

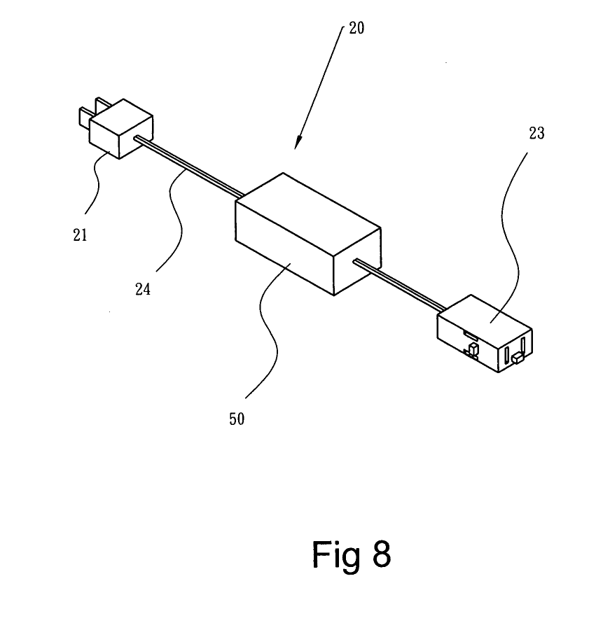

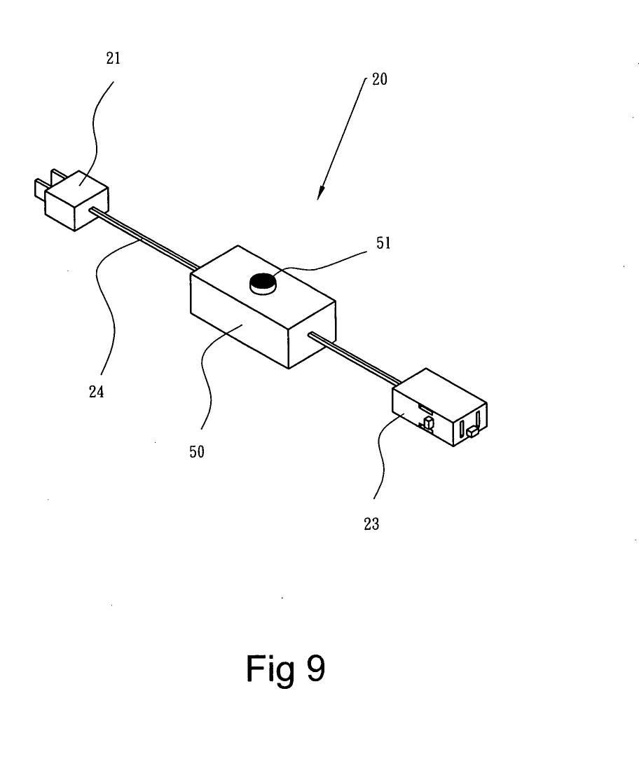

Referring to FIGS. 8 and 9, the rectifier module in accordance with the present invention comprises a plug (the first end connector) 21, the extension cable 24, the casing 50 containing therein the electronic circuit, and the second end connector 23 and the electronic circuit comprises a variable resistor, which is operated by an adjusting knob 51 that arranged on an outside surface of the casing 50.

One of the major functions of a lamp string is to realize decoration. If each LED lamp string has to carry a rectifier, then the more lamp strings positioned on a Christmas, the more rectifiers there are needed, which causes a burden to the aesthetics environment and is not so beautiful as compared to the traditional tungsten filament based lamp strings. Further, the general consumers have to take the additional costs for the rectifiers. Moreover, in the view point of operation safety, the more rectifiers the lamp strings need, the more likely that flaw products that incorporates flaw rectifiers may occur. Thus, the present invention, which uses the least quantity of rectifier, is excellent to ensure high product passing rate.

To summarize, the present invention has at least the following advantages:

(1) The cost for rectifier is reduced for each Christmas or each decorative scene requires only one singe rectifier module to control a great number of lamp strings.

(2) There is no need to provide an individual rectifier for each lamp string so that in use, the lamp strings do not carry a rectifier, which causes an obstacle to the improvement of overall aesthetic appearance.

(3) A variable resistor may be added to realize manual adjustment of brightness of the lamp strings.

(4) An electrical capacitor is added to ensure stability of current output.

(5) A fool-proof mechanism may be added to ensure incorrect plugging.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A rectifier module adapted to simultaneously connect to a plurality of light-emitting diode lamp strings, the rectifier module comprising:
a first connector;
an electronic circuit, which comprises a rectifier element, the electronic circuit being mounted to an extension cable, and an end of the extension cable carrying the first connector; and
a second connector mounted to an opposite end of the extension cable;
wherein the rectifier module is selectively connectable to one to twenty lamp strings.

2. The rectifier module as claimed in claim 1, wherein the rectifier element is selectively arranged in either the first connector, the second connector or a middle portion of the extension cable.

3. The rectifier module as claimed in claim 1, wherein the electronic circuit is arranged inside a plastic casing.

4. The rectifier module as claimed in claim 1, wherein the electronic circuit comprises a diode connected to a variable resistor and a capacitor.

5. The rectifier module as claimed in claim 1, wherein the electronic circuit comprises a diode connected to a constant resistor and a capacitor.

6. The rectifier module as claimed in claim 1, wherein the electronic circuit comprises a bridge rectification filter and a capacitor connected to a constant resistor.

7. The rectifier module as claimed in claim 1, wherein the electronic circuit comprises a bridge rectification filter and a capacitor connected to a variable resistor.

8. The rectifier module as claimed in claim 1, wherein the electronic circuit comprises a bridge rectification filter connected to a variable resistor.

9. The rectifier module as claimed in claim 1, wherein the electronic circuit comprises a bridge rectification filter connected to a constant resistor.

10. The rectifier module as claimed in claim 1, wherein the electronic circuit comprises two diodes to which a circuit comprised of two capacitor and a variable resistor is connected.

11. The rectifier module as claimed in claim 1, wherein the electronic circuit comprises two diodes to which a circuit comprised of two capacitor and a constant resistor is connected.
